(19) United States
(12) Patent Application Publication
(10) Pub. No.: US 2006/0048230 A1
(43) Pub. Date: Mar. 2, 2006

(54) Method for securing computer systems incorporating a code interpretation module

(75) Inventors: Patrice Hameau, Boulogne Billancourt (FR); Daniel Le Metayer, Le Chesnay (FR)

Correspondence Address: BROWDY AND NEIMARK, P.L.L.C.;624 NINTH STREET, NW, SUITE 300, WASHINGTON, DC, 20001-5303, US

(73) Assignee: Trusted Logic, Versailles (FR)

(21) Appl. No.: 10/540,501

(22) PCT Filed: Dec. 18, 2003
(86) PCT No.: PCT/FR03/03805

§ 371 Date: Jun. 23, 2005

(30) Foreign Application Priority Data
Dec. 24, 2002 (FR) 0216932

(51) Int. Cl. H04N 7/16

(52) U.S. Cl. 726/26

(57) ABSTRACT

The invention relates to a method of securing computer systems comprising at least one code interpretation module and memory capacity for storing the code to be interpreted. For said purpose, the invention consists in making more difficult attacks involving physical measures and/or requiring a synchronisation with the interpreted code, by introducing variants into the interpreted code runtimes and the measurable physical prints.

The present invention relates to securing computer systems comprising at least one code interpretation module and storage memory capacities for the code to be interpreted.

More specifically, its object is to solve problems for securing computer systems comprising at least one code interpretation module (a code being defined as a structured set of instructions) which will simply be called “interpreter” in the following (hardware interpreter: microcontroller, microprocessor or software: virtual machine) and storage memory capacities for the code to be interpreted (or interpreted code).

Said code may be directly written by a programmer, may be obtained automatically (which will be called code generation) from a source code in a language which is generally of a higher level or it may even result from a combination of automatic production and manual interventions.

Generally, it is known that most of the inventorized attacks against such computer systems are based on physical measurements (electromagnetic emission, etc.) during execution and require synchronization with the interpreted code. In other words, the intruder must determine at what time the interpreter is found executing certain functionalities of the code. Among the most known techniques, those developed in order to find a key in cryptographic algorithms by passively spying the physical emission of a circuit may be cited: in particular the attacks of the simple power analysis (SPA) and differential power analysis (DPA) type have been successfully used for discovering DES (“Data Encryption Standard”) keys. As an example, on an embedded Java platform (“Java Card”, “JEFF”, “J2ME” . . . ) these attacks may be used in order to try to obtain information on secrets handled by the virtual Java machine. These secrets may concern both the confidential data and the Java code itself.

More specifically, the object of the invention is therefore to suppress these drawbacks.

For this purpose, it proposes making attacks based on physical measurements and/or requiring synchronization with the interpreted code, more difficult, by introducing alternatives in the execution times of the interpreted code and the measurable physical imprints (for example, and not exclusively, electromagnetic emission, etc.).

According to the invention, this method essentially involves two types of alternatives in the execution times of the interpreted codes, in the following way:
by causing at certain places of an interpreted code bypasses towards new portions of code (which do not belong to the original code) in order to complicate the synchronization and the physical imprint of the execution, or
by proposing a plurality of implementations of certain instructions, each requiring a different execution time and/or having a different physical imprint and providing an identical result, so that two executions of this instruction within a same code may be performed by two different implementations.

Hence, by introducing distortions in the execution times and by modifying the physical effect of the execution, both types of the above alternatives will make any correlation attempt more difficult between the observed physical expressions of an interpreted code and its functionalities.

Advantageously, this method will be able to make the apparently executed code, different at each execution, and will therefore make the discovery of the actual code of the application, more difficult.

This method may involve:
for the first alternative:
   two modes for introducing “bypass codes”,
   four modes for realizing “bypass codes”,
for the second alternative:
   two modes for introducing “multiple implementations” of certain instructions,
   three modes for realizing “alternative codes” with a variable physical imprint and duration.

As regards the first alternative, the first mode for introducing “bypass codes” consists of introducing one or more specific so-called “bypass” instructions in certain particular locations of the code. This introduction may be made either manually or automatically upon generating the code. In the latter case, the code generator may be guided in order to produce these instructions by annotations inserted by the programmer in the source code and allowing the designation of portions of sensitive code (for example, and in a non-limiting way, encryption or access rights checking procedures). Execution of a bypass instruction by the interpreter causes branching towards an associated bypass code. This first method may also be improved by attaching different levels of security to bypass instructions and by associating them with all the more complex (or defensive with regards to security attacks as described above) bypass codes since their security level is high.

Concerning the first alternative, the second mode for introducing “bypass codes” consists of introducing the bypass code in the implementation of the interpreter itself: between the executions of two consecutive instructions of the code, the interpreter executes the bypass code, either systematically or selectively or randomly. For example, it may execute this code only when certain sensitive methods are called (typically from so-called API (application program interface) libraries).

The advantage of the first mode is to allow selective introduction of the executions of bypass code which leads to less penalty in terms of execution times if the number of such bypasses is small. It also allows implementation of so-called “discretionary” security policies, i.e., at the discretion of the applications.

On the other hand, the second mode will be more advantageous when the number of desired bypasses is large because the implementation of the method in the interpreter itself may then be optimized. Moreover, it allows implementation of so-called “proxy” security policies where checks are uniformly imposed on all the applications.

Both previous aforesaid introduction modes require the introduction of a bypass code. The invention proposes four modes to realize these bypass codes so that they introduce alternatives in the execution times and the measurable physical imprints.

Concerning the first alternative, the first mode for realizing “bypass codes” with physical imprint and variable duration consists of performing a so-called “superfluous” calculation depending on data known at execution (which may therefore differ at each execution). The superfluous calculation should be without any effect on the final result of the execution of the interpreter. A simple example of such a calculation is a parity test for a dynamic datum (known at execution) which may either lead to a void action, or to the adding of an item to a stack followed by its immediate removal. It should be noted that the number of possible actions is not necessarily limited to two. A large possible number of actions will lead to significant variability in the execution time and the physical imprint of the bypass code.

The second mode for realizing “bypass codes” improves the first mode by providing it with a random draw of an extra datum during the execution of the superfluous calculation, said extra datum being used in the calculation performed by the bypass code (for example in a test of said code). This random draw has a new variable item and makes the execution time and the physical imprint of the bypass code, even less predictable.

The third mode for realizing “bypass codes” improves the efficiency of the two preceding ones by replacing the test for deciding on the next action with a branching in a so-called indirection table, i.e., containing the addresses of possible actions, at an index calculated from variable items (dynamic datum and/or result from a random draw).

The fourth mode for realizing “bypass codes” improves the first embodiment (and therefore the three other ones) by considering a superfluous calculation which, while remaining without any effect on the final result, has external characteristics (physical imprint) of a particular sensitive calculation (for example encryption or decryption) without any relationship with the actual code of the application. Such a superfluous calculation enables an attacker to be fooled, who would attempt to infer secrets by measuring the physical effect of the execution of the application. Such a method may be described as a “software decoy” since its goal is to induce in error the attackers by making them believe in the presence of said sensitive calculation in the actual code of the application. This mode may simply be achieved by implementing the relevant sensitive calculation without retaining its result.

Concerning the second alternative, the first mode for “introducing multiple implementations” of certain instructions, consists of enriching the set of instructions recognized by the interpreter with a plurality of implementations for a given instruction. These implementations will be achieved so as to have different physical imprints and different execution times while producing an identical result. Any of these implementations may be used in the code indiscriminately. This use may be performed either manually by programming or automatically during code generation. In the latter case, the code generator may be guided, in order to produce these instructions, by annotations inserted by the programmer into the source code and allowing designation of sensitive code portions (for example, and in a non-limiting way, encryption or access rights checking procedures). This first mode may also be improved by attaching different security levels to the implementations of instructions and associating them with all the more complex (or defensive with regard to security attacks) implementations since their security level is high.

Concerning the second alternative, the second mode for introducing “multiple implementations” of certain instructions, consists of comprising in the actual implementation of the instruction, a branching to an alternative code portion which will dynamically determine the implementation to be executed.

The advantage of the first mode is to minimize additional costs in terms of execution times as the selection of the instruction implementation to be applied is determined before execution. It also allows implementation of so-called “discretionary” security policies, i.e., at the discretion of the applications.

The advantage of the second mode is to further complicate the attacks requiring synchronization with the code since two consecutive executions of the same instruction (at the same location in the code) will be able to take different execution times and to provide different physical imprints. Moreover, this second mode allows implementation of so-called “proxy” security policies where the checks are uniformly imposed to all the applications.

Both modes do not mutually exclude each other: a realization may comprise a multiplicity of implementations for a given instruction, certain of them (or all of them) being implemented by branching to an alternative code portion dynamically determining the implementation to be executed.

The aforesaid second mode of the second alternative requires the introduction of an alternative code associated with an instruction. The invention proposes three modes for realizing this alternative code so that it introduces different implementations in the execution times and the measured physical imprint.

Concerning the second alternative, the first mode for realizing “alternative codes” with a physical imprint and variable duration consists of proposing a plurality of different implementations of the instruction and to condition the choice of the executed version to a dynamical test, i.e., depending on data known at execution. A simple example of such a calculation is a parity test of a dynamical datum (known at execution). A large number of implementations will lead to significant variability in execution time and in the physical imprint of the alternative code.

The second mode for realizing “alternative codes” improves the first mode by providing it with a random draw of a datum which is then used for achieving the test leading to the dynamical choice of the executed version. This random draw adds a new variable item and makes the execution time and the physical imprint of the alternative code, even less predictable.

The third mode for realizing “alternative codes” improves the efficiency of the two preceding ones by replacing the test for deciding on the selected version with a branching in a indirection table (containing the addresses of the available versions) at an index calculated from variable items (dynamical datum and/or result from a random draw).

Thus, by introducing alternatives in the execution times of the interpreted codes and therefore in the physical imprints, it is possible to make the attacks based on said physical imprints, more difficult so that an action coded in the implementation of the application may have different electronic signatures and occurring at variable execution times.

The implementation of the aforesaid interpreted codes will be performed on modules for interpreting software code such as virtual machines of the JAVA family and on modules for interpreting physical code of the microcontroller or microprocessor type.

1. A method for securing computer systems comprising at least one code interpretation module and memory capacities for storing the interpreted code having measurable physical imprints, said method with the purpose of making attacks based on physical measurements or requiring synchronization with the aforesaid interpreted code, more difficult, consisting of introducing alternatives for executing the interpreted code, said alternatives having an effect on the execution times of the interpreted code or on its measurable physical imprint.

2. The method according to claim 1, comprising bypasses towards new code portions, so-called “bypass codes”, which do not belong to the original code.

3. The method according to claim 1, comprising a plurality of implementations of certain instructions, each requiring a different execution time or having a different physical imprint while providing an identical result.

4. The method according to claim 2, comprising a first mode for introducing “bypass codes” consisting of introducing one or more instructions specific to certain particular locations of the code, either manually or automatically during the generation of the aforesaid code.

5. The method according to claim 4, wherein the bypass instructions are associated with security levels which correspond to complexity levels of their bypass code, the most complex being considered as the most defensive with regard to security attacks requiring synchronization with the code or measurement of its physical imprint.

6. The method according to claim 2, comprising a second mode for introducing “bypass codes” consisting of introducing the bypass code in the implementation of the interpreter itself.

7. The method according to claim 6, wherein the bypass code introduced into the implementation of the interpreter is executed either systematically by the interpreter or selectively or randomly.

8. The method according to claim 2, comprising a first mode for realizing “bypass codes” consisting of performing a so-called “superfluous” calculation depending on data known at execution.

9. The method according to claim 2, comprising a second mode for realizing “bypass codes” consisting of providing the aforesaid first mode with a random draw of an extra datum during the execution of the superfluous calculation, said extra datum being used in the calculation performed by the bypass code.

10. The method according to claim 8, wherein the aforesaid first mode for realizing “bypass codes” is improved by attaching different security levels to the implementations of instructions and associating them with all the more complex implementations.

11. The method according to claim 2, comprising a third mode for realizing “bypass codes” consisting of replacing in the aforesaid first and second modes the test for deciding on the next action by a branching in an indirection table containing the addresses of possible actions at an index calculated from variable items (dynamical datum and/or result from a random draw).

12. The method according to claim 2, comprising a fourth mode for realizing “bypass codes” consisting of performing a superfluous calculation having the external characteristics of a particular sensitive calculation.

13. The method according to claim 3, comprising a first mode for introducing a plurality of implementations of certain instructions consisting of enriching the set of instructions recognized by the interpreter with a plurality of implementations for a given instruction; the aforesaid instructions are performed either manually by programming or automatically upon code generation.

14. The method according to claim 3, comprising a second mode for introducing the aforesaid plurality of implementations of certain instructions consisting of comprising in the actual implementation of the instruction, a branching to a portion of at least one alternative code with a variable physical imprint or duration, which dynamically determines the implementation to be executed.

15. The method according to claim 14, comprising a first mode for realizing the aforesaid alternative code consisting of proposing a plurality of different implementations of the instruction and by conditioning the choice of the executed version to a dynamical test, i.e., depending on data known at execution.

16. The method according to claim 14, comprising a second mode for realizing the aforesaid alternative code consisting of improving the aforesaid first mode for realizing “alternative codes” by providing it with a random draw for achieving the test leading to the dynamical choice of the executed version.

17. The method according to claim 14, comprising a third mode for realizing the aforesaid “alternative code” consisting of improving the aforesaid first and second modes for realizing “alternative codes” consisting of replacing the test for deciding on the selected version with a branching in an indirection table containing the addresses of the available version at an index calculated for variable items.

18. The method according to claim 1, being implemented on a module for interpreting software code, a so-called virtual machine.

19. The method according to claim 18, wherein said virtual machine is a Java platform.

20. The method according to claim 1, being implemented on a module for interpreting physical code.

21. The method according to claim 1, being implemented on an embedded system and on an interpretation module of the microcontroller or microprocessor type.
